(19) United States
(12) Patent Application Publication
(10) Pub. No.: US 2013/0226727 A1
(43) Pub. Date: Aug. 29, 2013

(54) APPLICATION FOR BUYERS TO OPTIMIZE SAVINGS WHEN SHOPPING FROM MULTIPLE SUPPLIERS

(71) Applicant: Sebastian J. Serra, Haverhill, MA (US)

(72) Inventor: Sebastian J. Serra, Haverhill, MA (US)

(21) Appl. No.: 13/781,699

(22) Filed: Feb. 28, 2013

Related U.S. Application Data
(60) Provisional application No. 61/605,162, filed on Feb. 29, 2012.

(51) Int. Cl. G06Q 30/06

(52) U.S. Cl. CPC G06Q 30/0611
USPC 705/26.4

(57) ABSTRACT

An automated bid management process speeds up the comparison of product pricing from multiple suppliers. The process and system of the present invention can determine the optimal order combination to result in the greatest savings to the buyer. The bid management process allows suppliers to submit their pricing directly into an application. Buyers have the ability to create a personal marketplace within the system and have select suppliers bid for their business. Submitting the orders can be fully automated and the application can provide controls and reporting system to allow full control and personalization of the process. The system and methods can take all the predetermined information in the system, such as minimum orders, delivery data, buyer preferences, and the like, and automatically award the order to the supplier(s) that offer the greatest savings to the buyer.

### CROSS-REFERENCE TO RELATED APPLICATION

This application claims the benefit of priority of U.S. provisional application No. 61/605,162, filed Feb. 29, 2012, the contents of which are herein incorporated by reference.

### BACKGROUND OF THE INVENTION

The present invention relates to buying systems and methods and, more particularly, to a system and method for buyers to optimize savings when shopping for a product from multiple suppliers.

Buyers spend a lot of time gathering current pricing from suppliers. It takes a lot of time to analyze prices from multiple suppliers to determine the optimal order combination to award each supplier, guaranteeing the most savings. As a result, most buyers don't buy efficiently and pay more than they should.

Conventional buying processes are manual and very time consuming. Other systems require the buyer to get current pricing from the Suppliers, or rely on their current data, which may or may not be up to date. While there are automated buying systems that may compare prices of various items, these systems are cumbersome, time consuming and subject able to human error. They are also unreliable as a result of pricing/timing issues.

As can be seen, there is a need for an application that allows for buyers to optimize their savings when shopping from multiple suppliers.

### SUMMARY OF THE INVENTION

In one aspect of the present invention, a computer application for managing purchasing of goods or services from one or more suppliers, the application including computer code, disposed on a non-transient computer readable medium, the computer code having a first code segment providing an administrator access to set up and maintain buyers and suppliers in a database; a second code segment providing a supplier access so that suppliers can update products, pricing and terms so that buyers will have purchasing information readily available; a third code segment providing a buyer access so that buyers may enter a purchase request with one or more items; and a fourth code segment filling the purchase request from the buyer with the most cost effective manner using the buyer's preferences.

In another aspect of the present invention, a computer-assisted method for determining a best order price in an order of multiple items from multiple suppliers comprises setting up and maintaining buyers and suppliers in a database; providing a supplier access to the database so that suppliers can update products, pricing and terms so that buyers will have purchasing information readily available; providing a buyer access to the database so that buyers may enter the order; and filling the order from the buyer with the most cost effective manner using the buyer's preferences, assigning each of the multiple items to various ones of the multiple suppliers.

These and other features, aspects and advantages of the present invention will become better understood with reference to the following drawings, description and claims.

### BRIEF DESCRIPTION OF THE DRAWINGS

FIG. 1 is a flowchart providing an overview of a purchasing process according to an exemplary embodiment of the present invention;

FIG. 2 is a flowchart describing a remove supplier sub-process for removing suppliers below certain thresholds, as referred to as “Sub Proc. 1” in the purchasing process of FIG. 1;

FIG. 3 is a flowchart describing a main optimization sub-process as referred to as “Sub Proc. 2” in the purchasing process of FIG. 1;

FIG. 4 is a flowchart describing a sub-process for removing items from suppliers as referred to as “Sub Proc. 3” in FIGS. 2 and 3;

FIG. 5 is a flowchart describing a sub-process for keeping suppliers as referred to as “Sub Proc. 4” in FIG. 3; and

FIG. 6 shows flowcharts describing various item mapping routines for new suppliers, existing suppliers and new file formats.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an automated bid management process that speeds up the comparison of product pricing from multiple suppliers. The process and system of the present invention can determine the optimal order combination to result in the greatest savings to the buyer. The bid management process allows suppliers to submit their pricing directly into an application. Buyers have the ability to create a personal marketplace within the system and have select suppliers bid for their business. Submitting the orders can be fully automated and the application can provide controls and reporting system to allow full control and personalization of the process. The system and methods can take all the predetermined information in the system, such as minimum orders, delivery data, buyer preferences, and the like, and automatically award the order to the supplier(s) that offer the greatest savings to the buyer.

The system of the present invention may be a software application. The application may be designed to work on a web or cloud-based interface, for example, allowing buyers, suppliers and administrators to all have ready access to the system. The application may be designed to work on other platforms, such as tablet computers, smartphones, and other systems. Moreover the application may be designed as stand-alone software that provides a user interface to allow the user to interact with the system. Regardless of the platform, the application should have shared data so that, for example, pricing updated by suppliers is readily available by the application for buyers.

The application of the present invention may include computer code written in any one or more of available coding languages. The computer code may be disposed on a tangible computer readable medium and may include code sequences adapted to perform the various functions of the methods as herein described.

The application can capture all the requirements and needs of both suppliers and buyers and can be programmed to understand the process and the steps and variables that impact the cost associated with each buying decision. The application can automate all these processes to create an algorithm to consider all the factors to determine the optimal combination, ensuring the greatest cost savings to the buyer. The buyer will have the ability to automate the bid management for multiple supplier pricing, resulting in the creation of healthy competition and cost savings through competitive market forces. The buyer will save money through efficiencies realized within the ordering process and by having real time data available so they can make informed business decisions.

The systems and methods of the present invention are designed as a business to business application, providing an internet-based personal marketplace where both buyers and suppliers have the ability to choose with whom they want to trade. The system of the present invention can be used by operators to increase employee productivity, improve the flow of information with suppliers, refine the accuracy of orders and reduce food cost (when the application is used in the food service industry.

The platform of the present invention provides the buyer with a comprehensive order management solution, including application software and database services, that automates and streamlines the following tasks: (1) choosing which suppliers to include their marketplace (and ability to manage supplier list); (2) providing real-time market data and analytics for buyer specific inquiries; (3) automatically managing and cross referencing data from multiple suppliers for accurate comparison; (4) breaking down product pack size and weight for lowest unit of measure comparisons; (5) developing an order; (6) disbursing an order to multiple suppliers electronically while maximizing efficiencies and cost savings; (7) calculating optimal savings while factoring in all operational variables; (8) moving items around between suppliers; (9) setting supplier preferences by product; (10) acknowledging the order to the initiator; (11) quantifying and displaying savings to the operator; and (12) providing order history and usage reports.

The platform of the present invention allows suppliers with the following: (1) interfacing directly into the system; (2) choosing which buyers to include in their marketplace (and ability to manage buyer list); (3) uploading multiple pricing structures which can be buyer specific; (4) selecting which buyer they choose to show pricing; (5) flexibility for changing pricing strategies quickly and easily for any buyer; (6) creating delivery profile by geography; (7) providing a delivery criteria/profile that can be set as general, route and or buyer specific; (8) setting delivery dates and times; (9) setting non-delivery dates and weekend/Holiday schedule; and (10) receiving orders electronically.

The platform of the present invention provides a proprietary algorithm that determines the optimal savings on every order while satisfying both the buyer's specific order criteria and supplier's delivery and order requirements. The platform can operate using cloud technology, allowing the advantage of scalability. Its internet based platform gives users the flexibility to be mobile and the ability to analyze market prices in real-time from suppliers in their personal marketplace

The platform can be used, for example, in the food service industry. However, it should be noted that adaptations can be realized so that the application and methods may be used across many other industries where buyers have the ability to purchase goods and services from multiple suppliers. Such adaptations are within the scope of the present invention.

The application may be modified to allow the application host or manager to make payments to suppliers on the buyer's behalf. The application host or manager may also be able to negotiate volume discounts by pooling all the buyers' purchases together with the intention of getting better pricing for members using the application.

As used herein, the term “admin” identifies an administrator of the application that can manage system level tasks, such as setting up users or maintaining referential data. An admin may be an employer of the application provider, for example, that manages users, the catalog (merchandising), geographies, suppliers (and XML mapping documents), and buyer accounts. The admin user type may be used for system administration, customer support, customer sales, merchandising and the like.

A Supplier user type may be assigned by suppliers to manage their profile information, credit application, buyer special prices and product pricing. One physical supplier can have multiple users, however all users share the same responsibilities within the application. A physical supplier has at least one supplier user.

A Buyer Chain Supervisor is a user type that manages the information associated with a chain of restaurants, for example. A chain can have one or more locations associated with it. A chain supervisor manages the payment information and product list for the entire chain. A chain will have at least one user with the role of chain supervisor. This role has all the responsibilities of a Buyer Supervisor (see below) for the locations associated with the chain.

A Buyer Order Placer is a user type that may be referred to as an “order placer”. This user manages their product list, creates and modifies orders, and reviews order history. One restaurant, referred to as a buyer, can have multiple users with a role of order placer. A buying location does not need to have an order placer, as a buyer supervisor can fill this role.

A Buyer Supervisor is a user type that manages their restaurant's profile, application subscription and payments, supplier list, and can view their reports. Also, a buyer supervisor has all the responsibilities of an order placer. One buyer location can have multiple buyer supervisors. Each location has at least one buyer supervisor.

The platform of the present invention can include a sign-in screen where buyers and suppliers that subscribe to the application may be given sign-in information to access the application. The subscription to the application may be performed on various bases, such as, per user, per site, per location, and the like.

A plurality of areas of the system can be only accessed by an administrator. The application may provide an administrator dashboard where important information for the administrator may be readily shown or available. The administrator functions may include user maintenance screens, geography maintenance screens, category maintenance screens, attribute maintenance screens, product maintenance screens, supplier maintenance screens, buyer location maintenance screens, and units of measure maintenance screens. Through these screens, one can see how easy it could be to adapt the application from restaurant supply purchasing to other purchasing applications. Through the administrator screens, if a supplier or buyer would like to subscribe to the service, they may be entered as a user through these screens and their information may be stored or edited through those screens as well.

The platform provides various supplier access areas. When a supplier signs into the application, they may initially be shown their supplier dashboard. This screen may include important information for the supplier and the format and layout and information may be customized as desired. The supplier may have access to edit their profile, edit their delivery profile, view and maintain buyers and edit buyers. Through these screens, the supplier may provide pricing for buyers, discounts, shipping time, minimum orders, and the like.

The platform of the present invention provides various buyer access areas. When a buyer signs into the application, they may initially be shown their buyer dashboard. Like the prior dashboards, the buyer dashboard may show important information for the buyer and may be customized as desired. The buyer screens may include screens for maintaining their profile, managing payments options, listing products and defining preferred suppliers, maintaining lists of suppliers, one or more pages to create orders, one or more pages to review orders, confirming orders, providing order reports, providing spending reports, providing “what-if reports (these reports may show theoretical spending if orders are fulfilled in various manners, for example), providing histories of orders, and providing weekly delivery reports. Other reports may be available, not only at the buyer level, but also for suppliers and administrators.

Various guiding rules can apply to calculate the least cost of order fulfillment. For example, no arbitrary preferential treatment is given to any supplier.

For example, the application does not use a rule such as using the first alphabetical supplier name in case of a tie. The rules of the application of the present invention are built to try to enhance the cost savings of the order while reducing strain on the system.

During the order creation process, if one supplier currently has one or more items, and another supplier doesn't, it is known that either the user has a preference for the supplier with the item(s), or that supplier has given them a better price on the prior selected items. In the case of a price tie, giving the supplier currently with items increases the odds of exceeding their minimums. Avoiding giving the supplier without items avoids the chance that the supplier is under a minimum.

In order for an order to be placed, at least one supplier must have their minimum met, thus in case of ties, preference can be given to suppliers with the lower order minimums to increase the chance of having at least one supplier. Also, with a lower minimum, it increases the likelihood of exceeding the minimum, giving the system items that it can later pull back if need be to get other suppliers over their minimum.

A user will not be able to proceed with the algorithm if any of the following occur: (1) they have overridden the best price of an item for a different supplier, either through a previously setup preference or manually changing the supplier on just this order, and that selected supplier is not at or at or above their order minimum; (2) they have an item only provided by one supplier and that supplier is under their order minimum; (3) there are no suppliers that can fulfill their order as each total is under each supplier's minimum; and (4) there are items in the order that no suppliers offer.

While placing an order, a user (buyer) can select items individually or in groups by entering quantities and submitting those items. As individual items or groups or items are added to the order, a user sees various notations on the order placement screen. The user sees an indication preventing any order entry if no suppliers support them on the selected order fulfillment date. This would happen if the buyers have not properly selected their suppliers and vice versa. In addition, delivery schedules, including holidays, could prevent a buyer from getting deliveries on a particular date. The order placer must either ensure proper relations have been set up with their suppliers or change the delivery date before they can proceed. This could also occur if the user wants next day delivery and it is after the cutoff time for all of their suppliers.

The buyer also sees, on the order screen, a current running total for all items based on the prices for each item in the order based on what supplier is currently selected for each item. Included in this total are all shipping fees and surcharges. A revert or refresh feature can be provided that would undo any supplier changes made by the user. Items would move back to the cheapest providers if they were moved during the order process by the user. This feature may not be available if item or supplier preferences are set up in advance of the order.

A list of all suppliers available to the buyer is shown. Under each supplier various information can be provided, including the following: (1) an indication under a supplier if they do not deliver on the selected order fulfillment date; (2) an indication if the order is for next day delivery and it is after the supplier's cutoff time; (3) the shipping minimum, shipping fees, order minimum and surcharges; (4) current total for all items shown under the supplier; (5) total if the provider would fulfill all items them offer in the order; and (6) an indication of how many of the items in the order the supplier offers. As items are selected by the user, they are shown under the selected provider and the system will first see if the buyer has an item/supplier preference, and will put the item under that supplier regardless of price, unless that supplier currently does not have pricing. If there are no preferences for the selected item, it will be placed under the supplier offering the cheapest price. If two or more suppliers have identical prices, it will be first given to a supplier if they have items but other supplier(s) don't currently have items in this order. If more than one supplier has items, item is ordered from the supplier that currently is closest to their order minimum buy not over it. If two or more suppliers are equal to their order minimum, the system uses the supplier with the lowest minimum. If the minimums are the same, the system uses the supplier with the lowest surcharge. If the surcharges are the same, the system uses a preferred supplier. If both suppliers are not preferred, the system can randomly select a supplier.

On the order screen, the buyer can see, along with the item description and quantity, the price for the selected supplier, along with an indication of the other suppliers that offer this item with their current price. The buyer also has the ability to move an item to a different supplier or to exclude a supplier. However, a user cannot exclude a supplier if that supplier is the only one to offer a particular item in an order. That item would have to be removed from the order prior to excluding the supplier.

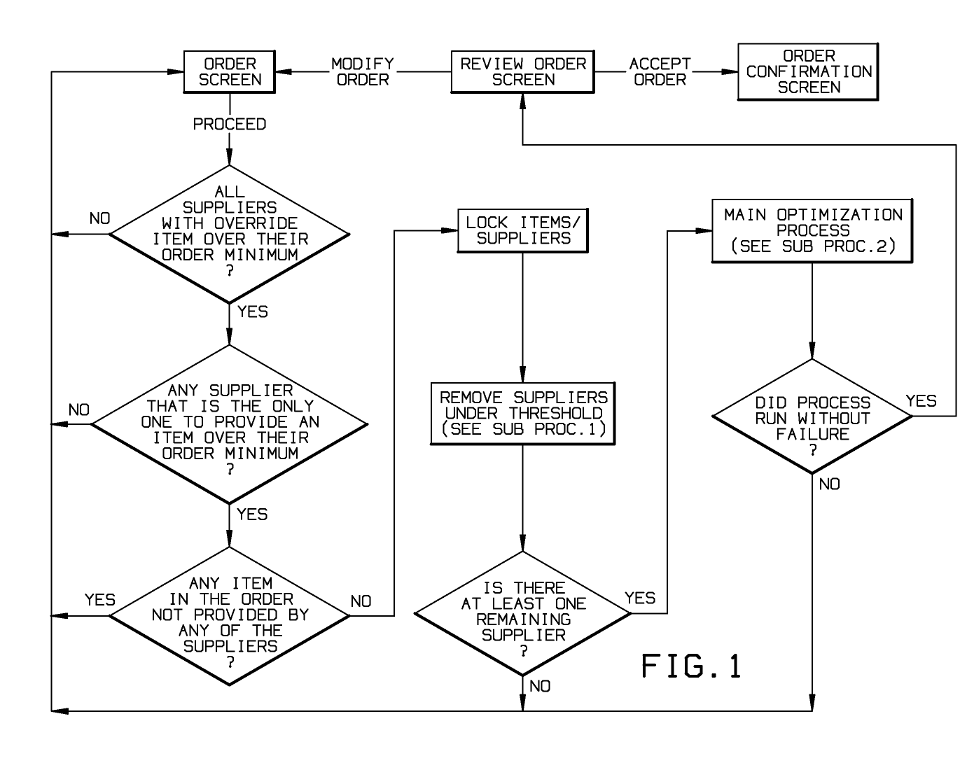

Referring now to FIGS. 1 through 6, flow charts are shown depicting various aspects of the present invention. These flow charts are exemplary processes and various changes in the process may be made within the scope of the present invention.

Going into the algorithm, one needs to ensure that if there is an item only sold by one supplier, or if the user has overridden the supplier for an item, those suppliers have met their order minimums. These suppliers are considered “locked” and must be used to fulfill the order. If the total of all items offered by a supplier is less than that supplier's order minimum, that supplier cannot be used by the algorithm. This supplier would be eliminated from the available suppliers for that order. If all suppliers are eliminated, the user would not be able to proceed and would have to modify their order to be able to proceed.

When leaving the order screen, each supplier has items, either because they are the lowest to offer that item, or the user has opted to use a particular supplier for a particular item. This is referred to as the order screen state.

If, at the time of the algorithm, one or more suppliers have exceeded their cutoff time, and the order is for next day delivery, that supplier is removed, even if that supplier had item overrides. If this results in either an item no longer sold by the supplier, or an item exclusively being sold by a supplier that is under their order minimum, the user is taken back to the order screen. The supplier that is now beyond the cutoff time is shown as such, and the items originally assigned to them are moved to the next cheapest suppliers.

If all preconditions have been met, items that have either been overridden by the user, or items that are only sold by one supplier are considered locked. These items cannot be moved by the algorithm. Furthermore, these suppliers are considered locked, meaning they too must be part of the order. Items that are not locked on a locked supplier can be move by the algorithm as long as doing so doesn't take the locked provider under their order minimum.

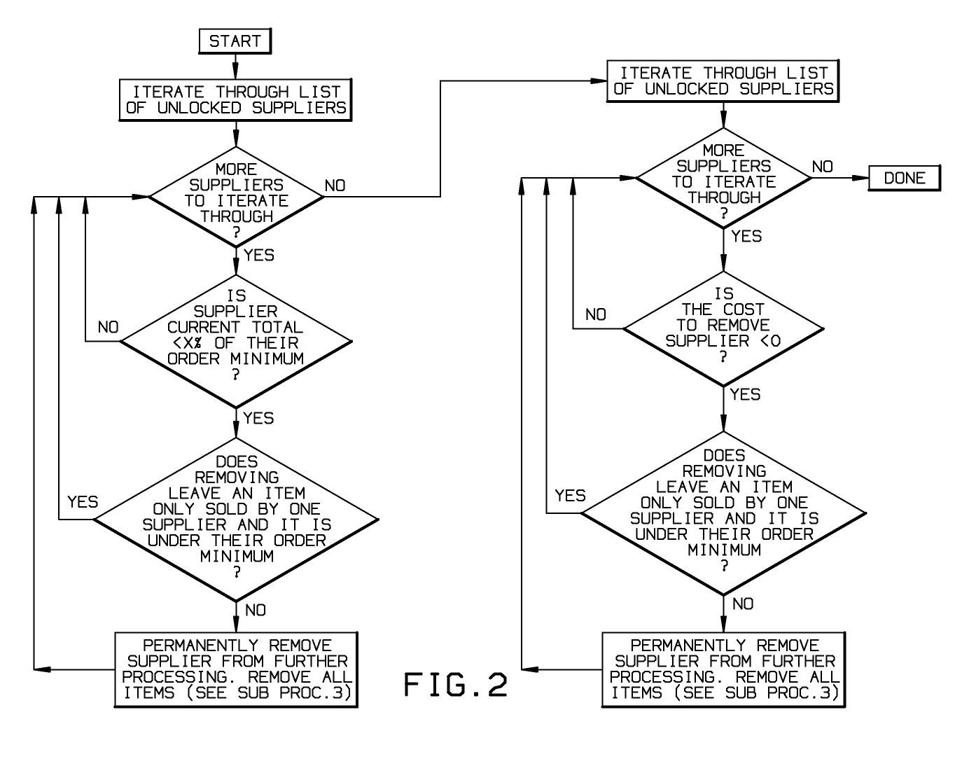

The algorithm can determine if any suppliers can be eliminated. The more suppliers available for an order, the longer it will take to process the optimal order total. While it cannot be guaranteed that eliminating a supplier won't also eliminate a best order, the algorithm can use rules with parameters that can be adjusted as the system learns over time. This is shown particularly in FIG. 2.

Suppliers can be eliminated in order of the furthest from the order minimum to the closest. Eliminating one supplier may put the next over its threshold or minimum order amount. If two suppliers are the same distance toward their order minimum, the supplier with the higher minimum is used first. If the two suppliers have the same minimum, the supplier with the higher surcharge plus shipping charge is eliminated first. If there is still a tie, the supplier can be chosen randomly.

Next, any non-locked supplier that is under X% toward their order minimum can be removed. This will work the same if the supplier uses dollar, weight or case amounts. For example, if the total of all items for that supplier is $20.00, and the order minimum is $100.00, the order is only 20% towards the minimum. This 20% figure is compared to the value of X%. If the 20 is greater than X, the supplier will be used in further steps in the algorithm. If 20 is less than X, the supplier is removed for this order and all items currently under this supplier are moved to the next cheapest. If later it is deemed that the system is eliminating too many suppliers, this number “X” can be set lower, or if the system performance is not optimal, this number “X” can possibly be increased to help with performance.

Suppliers are removed one by one and if eliminating a supplier causes an item to be only offered by one supplier, the algorithm will not eliminate the first supplier unless the one supplier who now offers the item is above their minimum. This supplier now becomes locked. That item is also locked.

Next, suppliers can be removed in order or lowest cost of removal. The cost to remove a supplier is calculated by taking the items that they currently have in the order (meaning only the items for which they have the lowest price out of all suppliers) and taking the difference to the next lowest price. The total of all these differences indicates how much the order would increase if this supplier were to be removed. From this amount, the surcharge is subtracted and if the current total order is under the shipping minimum, the shipping fee is also subtracted. Also, the “per shipment overhead cost” is subtracted. For example, supplier A has two items in its list and the first item costs $5.00 and the second costs $10.00. The next best price on item one (by any supplier) is $5.25 and the next best price on item two is $11.00. The cost to remove this supplier would be $1.25. If the supplier has $50.00 surcharge, the cost to remove it from the order would then be −$48.75. If two suppliers are the same distance toward their order minimum, the supplier with the higher minimum is used first. If the two suppliers have the same minimum, the supplier with the higher surcharge plus shipping charge is eliminated first. If there is still a tie, a supplier can be chosen randomly. If the cost of removal for a supplier is less than zero, this supplier is a candidate for removal. Suppliers are eliminated one by one. If eliminating a supplier causes an item to be only offered by one supplier, the other supplier is not removed unless the one supplier who now offers the item is above their minimum. This supplier and item then becomes locked. If a supplier is eliminated, all of its items are removed and distributed to the other suppliers.

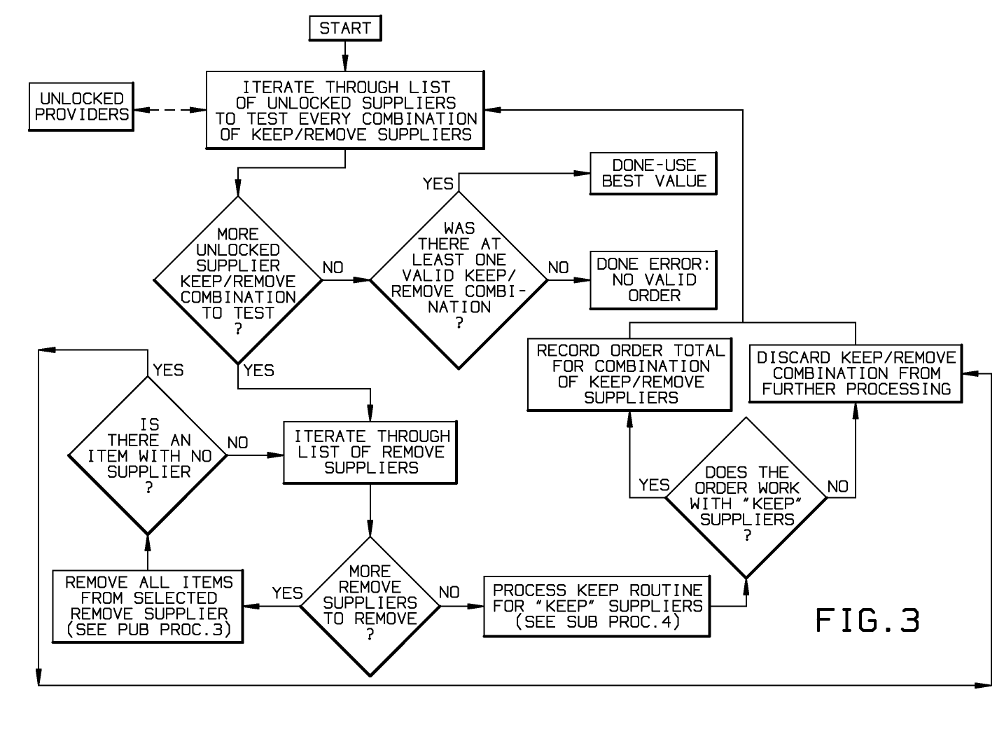

Referring now to FIG. 3, the main optimization process is entered to test all combinations or remaining suppliers. The algorithm can iterate through all “Keep/Remove” combinations of unlocked suppliers. For example, let's say there are five suppliers involved at this point, and two have been locked, that would result in the following combinations:

| | | | Supplier 4 | Suppler 5 |
|---|---|---|---|---|
| Supplier 1 | Supplier 2 | Supplier 3 | (locked) | (locked) |
| Keep | Keep | Keep | Always Keep | Always Keep |
| Keep | Keep | Remove | Always Keep | Always Keep |
| Keep | Remove | Keep | Always Keep | Always Keep |
| Keep | Remove | Remove | Always Keep | Always Keep |
| Remove | Keep | Keep | Always Keep | Always Keep |
| Remove | Keep | Remove | Always Keep | Always Keep |
| Remove | Remove | Keep | Always Keep | Always Keep |
| Remove | Remove | Remove | Always Keep | Always Keep |

Some of these combinations can be eliminated before even testing them. If an item is only sold by supplier 2 and supplier 3, then the algorithm cannot succeed with both the “Keep, Remove, Remove” and “Remove, Remove, Remove” combinations. Since the algorithm can maintain a matrix of suppliers and items, it can easily find such conditions that can be removed from the “Keep/Remove” list. The order in which the remaining combinations are processed is important to assist with performance. The remove all can be run first, but only needs to be run if there is at least one locked supplier. Next, individual “Keep” should be run. For example, “Keep, Remove, Remove” or “Remove, Keep, Remove”. Next, double “Keeps” should be run. For example, “Keep, Keep, Remove or “Keep, Remove, Keep”). Then three “Keeps” should be run.

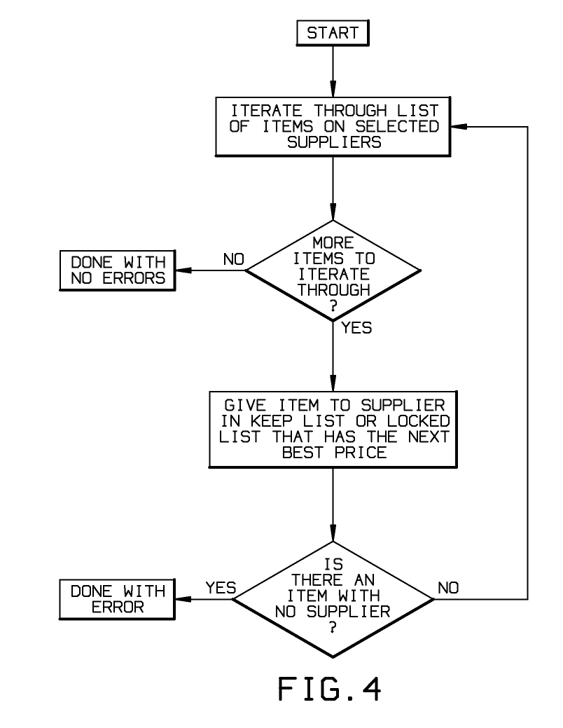

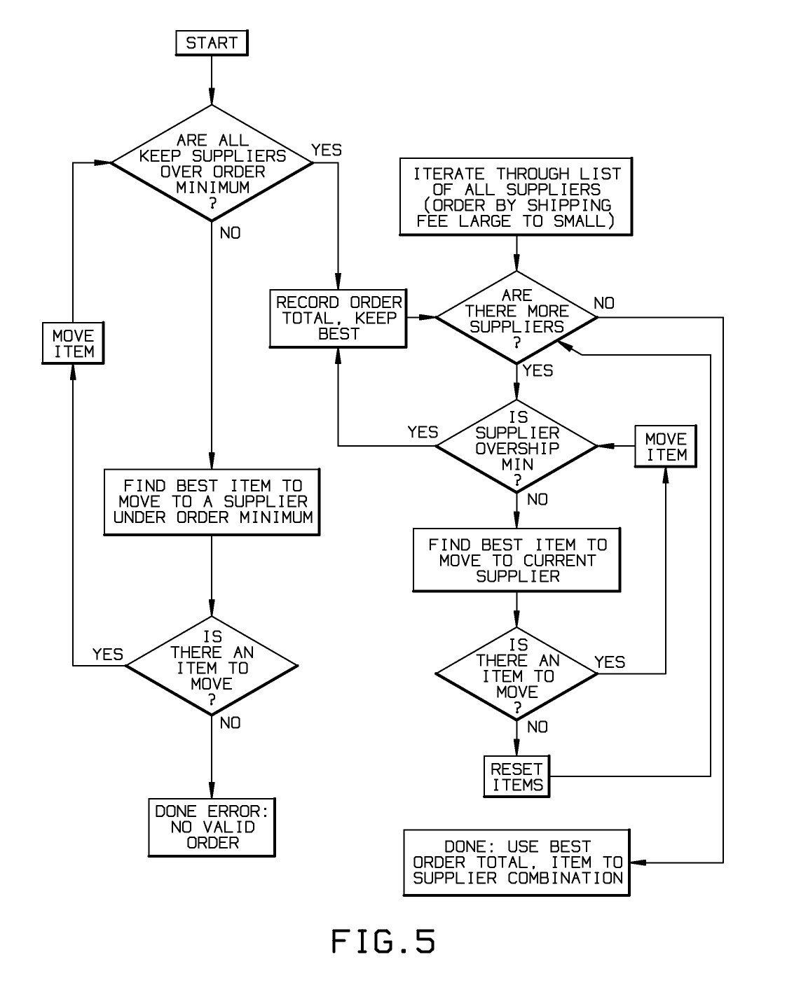

Next, all of the removes can be processed. This is illustrated in FIG. 4, for example. If there is an item with no supplier as a result of the removes, the algorithm can stop on this combination and proceed to the next, as this combination is not valid. If all of the removes are possible, the algorithm can process the Keep Routine, as described in FIG. 5.

If the “Keep” is not possible because one or more of the “Keep” suppliers is not over their order minimum, the algorithm knows that this combination is not valid and it proceeds to the next combination. Furthermore, the algorithm knows that any other combinations with the same “Keeps” won't work. For example, if “Keep, Remove, Remove” is being tested, and this is not valid, the algorithm knows that “Keep, Keep, Keep”, “Keep, Keep, Remove”, and “Keep, Remove, Keep” won't work and these combinations can be removed from the list of combinations that need to be tested. This is why combinations are processed in the order of fewest “Keeps” to most “Keeps”. As another example, if “Keep, Remove, Keep” is not valid, “Keep, Keep, Keep” is not valid either.

If the “Keep/Remove” scenario is possible, the order total and item to supplier combination is recorded. As each combination is tested, the best order total must be maintained. If it gets beat by a different combination, that new combination is saved and the old one can be discarded. Included in each total are shipping costs, surcharges, and per shipment overhead cost.

If no combinations are valid, the user must be taken back to the order placement screen with a message indicating that order minimums were not able to be achieved. If at least one combination was valid, the best order price and item to supplier combination is shown to the user on the order review screen.

Referring to FIG. 5, a keep routine flowchart is shown. If one or more suppliers are under their order minimum the algorithm finds the best item to move by considering all of the “unlocked” items on any supplier currently over their order minimum in the list of items that can be moved. This can be designated the “move from list”. If moving an item would put the supplier under their order minimum, it is not considered part of this list. Next, from the list of suppliers currently under their order minimum, consider all of the items that they offer, but do not currently have in their list because another supplier offers them cheaper. This is designated the “move to list”. The item with the smallest difference in price between the “move from list” and the “move to list” is the item chosen. This difference in price is calculated by taking the price of the current supplier (the one with the best price) minus the next cheapest price of a supplier in the move to list. If two or more items have the same difference, the item with the larger price is chosen. If two or more items have the same price, the item to be moved can be randomly picked.

If there are no more items to move and suppliers are still under their minimums, an error can be reported, meaning that this particular remove/keep combination is not valid. The moving of items can be continued until all suppliers are over their order minimums.

Once the moving of items is complete, the order total and supplier/item combinations are recorded. Included in each total are shipping costs, surcharges, and per shipment overhead cost.

Next, all suppliers are iterated through, starting with the supplier with the greatest shipping fee. If two or more suppliers have the same shipping fee, the algorithm starts with the highest percentage toward their shipping minimum, beginning with those over. If two or more have the same percentage toward their shipping minimum, one supplier can be randomly picked. Each time a supplier is worked on, it is marked as “processed”.

If a supplier is over their shipping minimum, the order total can be recorded if it is cheaper than the current saved order total. This supplier is then marked as processed and the algorithm moves to the next supplier.

If a supplier is not over their shipping minimum, the algorithm can look for items to be moved. To find the best item to be moved, the algorithm considers the “move from list” which includes all unlocked items from (1) processed suppliers that would not take them below their shipping minimum if they are over their shipping minimum, or their order minimum if they are under their shipping minimum; and (2) unprocessed suppliers that would not take them under their order minimum, even if they are over their shipping minimum. The algorithm can also consider a “move to list” as including all items for the current supplier that are currently in another suppliers list. Of the “move from list”, the algorithm can find the item with the least cost difference in the “move to list”.

If there are no items to move, this supplier cannot have its shipping fee removed. This supplier can be reset, meaning that if items were added to try to get it over the shipping minimum, they would be removed and put back on the cheaper supplier. If there are items to move, the algorithm can move and evaluate again if the supplier is over their shipping minimum. This can continue until there are no more suppliers to get over their shipping minimum and this item/supplier combination can be used to give the best price.

The system of the present invention can provided various notifications to users. For example, when an item is added to a supplier because there is an item/supplier preference previously set up by the buyer, the user can get the message “You have a preference to use this supplier for this item. You may not be getting the best price.” When an item offered, with a current price in the system, for only one supplier, the user can get the message “Only this supplier offers this item. Please ensure the order minimum is met for this supplier, or remove it from your order. When an item has the same price for more than one supplier, the user can get the message “This item is offered by other supplier(s) for the same price.” When an item/supplier preference can't be used because the supplier doesn't have current pricing for the item, the user can get the message “Your selected supplier for this item currently does not have pricing.” Of course, other messages and notifications can be provided by the system and the above are only examples of such notifications.

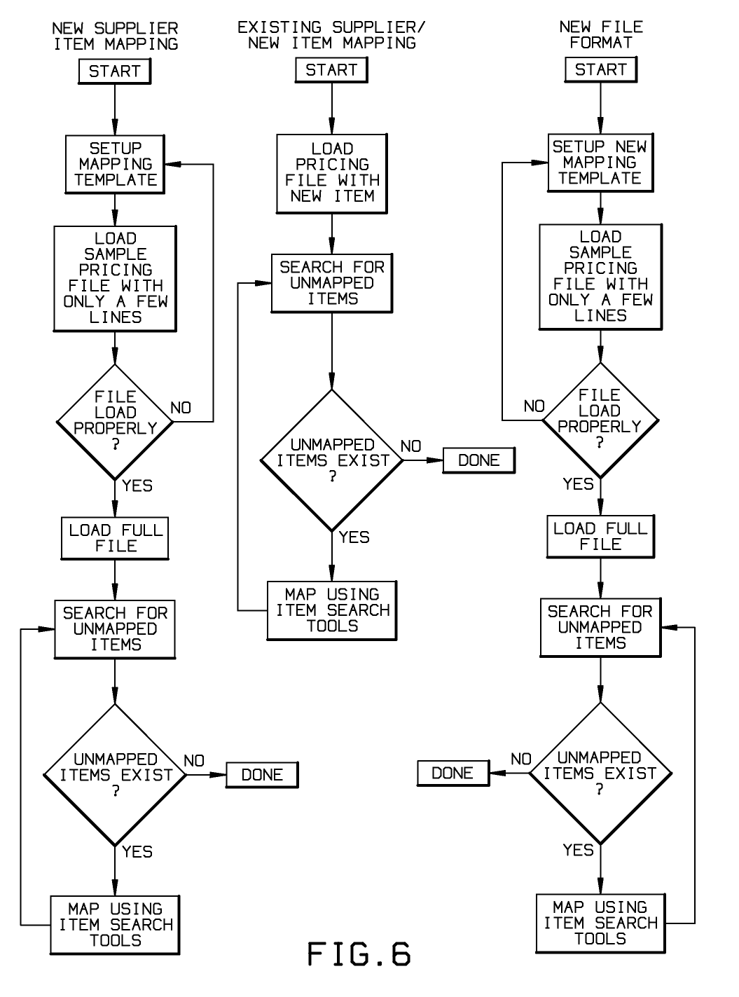

Referring to FIG. 6, when setting up a new supplier, the admin must create the mapping template that defines basically what data is in what columns. The admin can then load a sample pricing file with one or just a few sample lines. By going to the item cross reference maintenance for the supplier, the admin can see if the template was set up properly.

If the setup is incorrect, the mapping can be changed and tested again. Once the mapping is correct, the admin can run the entire price upload for the supplier. This would load all of the items in that file into the system. The admin can then use the item cross reference maintenance to search for unmapped items. Initially, this is all the items that were loaded. Then, the admin can map each item to a system item by using item search tools in the system.

After a supplier is set up, if they load a pricing file with a new item that has not yet been mapped, the admin would receive an alert on their dashboard. They would be able to search for unmapped items and set up the new mapping.

If a supplier is using a new file format, the admin would need to follow the same steps as when first creating the mapping. If the supplier's item descriptions haven't changed and the attribute and unit of measure values are still in the same mapping order, all previously mapped items will still be valid. No item mapping is required.

It should be understood, of course, that the foregoing relates to exemplary embodiments of the invention and that modifications may be made without departing from the spirit and scope of the invention as set forth in the following claims.

What is claimed is:

1. A computer application for managing purchasing of goods or services from one or more suppliers, the application including computer code, disposed on a non-transient computer readable medium, the computer code having:
a first code segment providing an administrator access to set up and maintain buyers and suppliers in a database;
a second code segment providing a supplier access so that suppliers can update products, pricing and terms so that buyers will have purchasing information readily available;
a third code segment providing a buyer access so that buyers may enter a purchase request with one or more items; and
a fourth code segment filling the purchase request from the buyer with the most cost effective manner using the buyer's preferences.

2. The computer application of claim 1, further comprising a fifth code segment ensuring that if there is a specific item only sold by a specific supplier, or if the buyer has indicated the specific supplier for the specific item, then the specific supplier meets their order minimum.

3. The computer application of claim 2, further comprising a sixth code segment determining if any suppliers can be eliminated from the purchase request.

4. The computer application of claim 3, further comprising a seventh code segment testing all combinations of suppliers remaining after any suppliers are eliminated.

5. The computer application of claim 4, further comprising an eighth code segment taking the buyer back to the buyer access with a message indicating that order minimums were not able to be achieved when the purchase cannot be fulfilled due to not meeting supplier minimums.

6. The computer application of claim 4, further comprising an eighth code segment providing a best order price and item-to-supplier combinations to the buyer when at least one combination is valid.

7. A computer-assisted method for determining a best order price in an order of multiple items from multiple suppliers, the method comprising:
setting up and maintaining buyers and suppliers in a database;
providing a supplier access to the database so that suppliers can update products, pricing and terms so that buyers will have purchasing information readily available;
providing a buyer access to the database so that buyers may enter the order; and
filling the order from the buyer with the most cost effective manner using the buyer's preferences, assigning each of the multiple items to various ones of the multiple suppliers.

8. The method of claim 7, further comprising ensuring that if there is a specific item only sold by a specific supplier, or if the buyer has indicated the specific supplier for the specific item, then the specific supplier meets their order minimum.

9. The method of claim 7, further comprising determining if any suppliers can be eliminated from the purchase request.

10. The method of claim 9, further comprising eliminating suppliers in order of suppliers furthest from their respective order minimums.

11. The method of claim 9, further comprising eliminating suppliers under a predetermined percentage toward their order minimum.

12. The method of claim 9, further comprising a testing all combinations of suppliers remaining after any suppliers are eliminated for optimizing order price.

13. The method of claim 12, further comprising taking the buyer back to the buyer access with a message indicating that order minimums were not able to be achieved when the purchase cannot be fulfilled due to not meeting supplier minimums.

14. The computer application of claim 12, further comprising providing the best order price and item-to-supplier combinations to the buyer when at least one combination is valid.
